(19) United States
(12) Patent Application Publication
(10) Pub. No.: US 2005/0108857 A1
(43) Pub. Date: May 26, 2005

(54) Pencil holder

(76) Inventors: Tony D. Wartian, Roseville, MI (US); Edward James Strzelecki, Oxford, MI (US)

Correspondence Address: REISING, ETHINGTON, BARNES, KISSELLE, P.C., P O BOX 4390, TROY, MI, 48099-4390, US

(21) Appl. No.: 10/723,544

(22) Filed: Nov. 26, 2003

(51) Int. Cl. B43K 25/00

(52) U.S. Cl. 24/10 R

(57) ABSTRACT

A clip is adapted to attach a pencil or the like to a wearer's cap. The clip is made of a flexible resilient material. The clip has a first channel adapted to receive a lower edge portion of a wearer's cap. The clip also has a slot which is adapted to receive a pencil to be gripped between the sides of the slot.

This invention relates generally to pencil holders and more particularly to a pencil-holding clip for attaching a pencil to a wearer's cap.

### BACKGROUND OF THE INVENTION

Workers usually keep pencils and like writing implements in a pocket when they are not being used. However, a pocket is not the most convenient place to store a pencil, especially for people working outside on a job such as a construction site, for example.

### SUMMARY OF THE INVENTION

The clip of the present invention is adapted to attach a pencil or the like to a wearer's cap. The clip is made of a flexible resilient material. The clip has a first channel adapted to receive a lower edge portion of a wearer's cap. The strip also has a slot which is adapted to receive a pencil to be gripped between the sides of the slot.

More particularly, the strip has a base, a first leg extending upwardly from an inner end of the base and a second leg extending upwardly from an outer end of the base. The strip has a third leg extending upwardly between the first and second legs. The first and third legs cooperate with a first portion of the base to provide a first generally U-shaped, upwardly opening channel. The second and third legs cooperate with a second portion of the base to provide a second upwardly opening channel. The strip has a tongue extending from an outer extremity of the second leg downwardly into the second channel. The third leg and the tongue cooperate to provide a generally V-shaped, upwardly opening, pencil-receiving slot. The first channel is adapted to receive and grip a lower edge portion of the wearer's cap. The slot is adapted to receive a pencil and be gripped between the third leg and the tongue.

Preferably the tongue has steps along its length spaced different distances from the third leg to cooperate with the third leg in holding pencils of different diameters. The tongue also slants from its outer extremity downwardly toward the third leg. Preferably barbs on the first and third legs are provided to more effectively grip and hold the lower edge portion of the cap.

One object of this invention is to provide a pencil-holding clip having the foregoing features and capabilities.

Other objects, features and advantages of the invention will become more apparent as the following description proceeds.

### BRIEF DESCRIPTION OF THE DRAWINGS

FIG. 1 is an elevational view showing a clip attaching a pencil to a wearer's cap;

FIG. 2 is a perspective view of the clip;

FIG. 3 is a front view of the clip; and

FIG. 4 is a view similar to FIG. 3 but shows the lower edge portion of the cap gripped in a channel of the clip, and a pencil gripped in a slot of the clip.

### DETAILED DESCRIPTION OF THE PREFERRED EMBODIMENT

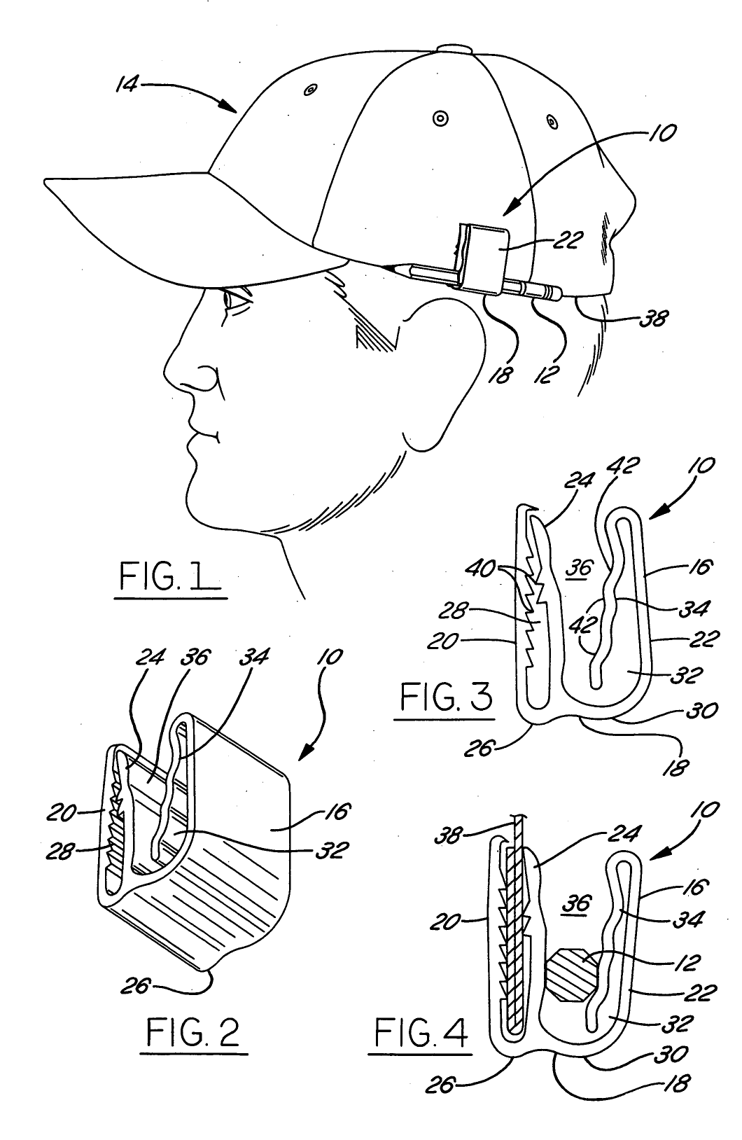

Now referring more particularly to the drawings, there is shown a pencil-holding clip 10 for attaching a pencil 12 or similar writing implement to a cap 14. In FIG. 1 the cap 14 is shown being worn on the head of an individual.

Referring more particularly to FIGS. 2-4, the pencil-holding clip 10 is made of a strip 16 of flexible resilient material, preferably a suitable plastic. The strip 16 has a base 18. The strip 16 is turned upwardly at an inner end of the base 18 to provide a first upwardly extending leg 20. The strip 16 is turned upwardly at an outer end of the base 18 to provide a second upwardly extending leg 22 spaced from the leg 20. The strip has a third leg 24 extending upwardly from the base 18 between and spaced from the first and second legs 20 and 22.

The first and third legs 20 and 24 cooperate with a first portion 26 of the base to provide a first generally U-shaped, upwardly opening channel 28. The second and third legs 22 and 24 cooperate with a second portion 30 of the base to provide a second upwardly opening channel 32.

The strip 16 has a tongue 34 extending from an outer extremity of the second leg 22 downwardly into the second channel 32 in spaced relation to the second and third legs 22 and 24. The second leg 22 and the tongue 34 cooperate to provide a generally V-shaped, upwardly opening, pencil-receiving slot 36.

The entire clip 10, including the strip 16, the base 18, the legs 20, 22 and 24, and the tongue 34 are of one-piece, integral construction and made of a suitable plastic material.

The first channel 28 is adapted to receive and grip a lower edge portion 38 of the cap 14. The slot 36 is adapted to receive the pencil 12 or any similar writing instrument, to be gripped between the third leg 24 and the tongue 34.

As shown in FIG. 1, the clip 10 is attached to the cap 14 by inserting the lower edge portion 38 of the cap 14 downwardly into the channel 28. In this position, the slot 36 is on the outer side of the cap 14 in a position to receive a pencil 12 pressed downwardly between the third leg 24 and the tongue 34 and to be gripped between the third leg 24 and tongue 34.

Preferably, one or both of the legs 20 and 24 have sharp edges or barbs 40 along there inner surfaces adapted to grip the material of the lower edge portion of the cap 14 and to prevent the clip 10 from accidentally becoming separated from the cap 14.

Preferably the tongue 34 is formed into a stepped configuration having a series of steps 42 which, in a direction toward the lower free end of the tongue 34, are disposed closer and closer to the leg 24 to make it convenient for pencils of different diameters to be gripped so that they will not accidentally fall out. Of course the pencil may be removed from the slot 36 very easily either by moving it in the direction of its length as shown in FIG. 1 or by lifting it upwardly.

The entire clip 10 is made of a flexible resilient material and is shown in its natural free state condition in FIGS. 2 and 3. The leg 24 may be flexed slightly away from the leg 20 when the lower edge of the cap 14 is inserted therein and then will flex back into a position tightly gripping the lower edge portion of the cap 14 between the legs 20 and 24. Likewise, the tongue 34 is flexible and can be flexed away from the third leg 24 when the pencil 12 is inserted therein. The pencil 12 is thus tightly gripped but not gripped so tightly that it can not be easily removed.

1. A pencil-holding clip comprising:
a strip of flexible resilient material,
said strip having a base,
said strip being turned upwardly at an inner end of said base to provide a first upwardly extending leg,
said strip being turned upwardly at an outer end of said base to provide a second upwardly extending leg spaced from said first leg,
said strip having a third leg extending upwardly from said base between and spaced from said first and second legs,
said first and third legs cooperating with a first portion of said base to provide a first generally U-shaped, channel having an open upper end,
said second and third legs cooperating with a second portion of said base to provide a second upwardly opening channel,
said strip having a tongue extending from an outer extremity of said second leg downwardly into said second channel in spaced relation to said second and third legs,
said second leg and said tongue cooperating to provide a generally V-shaped, upwardly opening, pencil-receiving slot,
said first channel being adapted to receive and grip a lower edge portion of a wearer's cap;
said slot being adapted to receive a pencil to be gripped between said third leg and said tongue,
said first channel throughout its length being substantially straight and parallel to said first and third legs to facilitate the downward insertion of the lower edge portion of the cap into said first channel,
said first and third legs having barbs adapted to grip and hold the lower edge portion of the cap,
said tongue having steps along its length spaced different distances from said third leg to cooperate with said third leg in holding pencils of different diameters, and
said tongue slanting downwardly from the outer extremity of said second leg toward said third leg.

2-6. (canceled)
